(19) United States
(12) Patent Application Publication
(10) Pub. No.: US 2009/0302636 A1
(43) Pub. Date: Dec. 10, 2009

(54) Rear Window Arrangement for a Motor Vehicle

(75) Inventor: Michael Koch, Boeblingen (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/093,391

(22) PCT Filed: Oct. 30, 2006
(86) PCT No.: PCT/EP06/10409

§ 371 Date: Sep. 23, 2008

(30) Foreign Application Priority Data
Nov. 12, 2005 (DE) 10 2005 054 067.8

(51) Int. Cl. B60J 1/00

(52) U.S. Cl. 296/146.16

(57) ABSTRACT

A rear window arrangement for a motor vehicle has an intrinsically rigid rear window which can be moved by means of a guide device between an upper position and a lowered position. A receiving space behind the passenger compartment is provided for the rear window within the motor vehicle. The rear window has a curvature in the vertical direction of the vehicle and can be moved along a curved movement track by means of the guide device.

This application is a national stage of PCT International Application No. PCT/EP2006/010409, filed Oct. 30, 2006, which claims priority under 35 U.S.C. §119 to German Patent Application No. 10 2005 054 067.8, filed Nov. 12, 2005, the entire disclosure of which is herein expressly incorporated by reference.

The invention relates to a rear window arrangement for a motor vehicle, having an intrinsically rigid rear window.

In a rear window arrangement of this type, such as disclosed, for example, German patent document DE 43 20 603 C2, an intrinsically rigid rear window made of glass can be moved by a guide device between an upper position (in which the rear window closes off the passenger compartment of the motor vehicle to the rear) and a lowered position. For this purpose, a receiving space for the rear window is provided within the motor vehicle behind the passenger compartment, such that said rear window can be accommodated, virtually entirely within the motor vehicle. After the rear window has reached its fully lowered position within the receiving space, the rear roof part, which includes the guides of the rear window, can be folded down together with an upper roof part of a convertible top into a convertible-top storage space.

One disadvantage of this known rear window arrangement is that, due in particular to its very deep vertical extent, the receiving space behind the passenger compartment requires a very large amount of construction space in the rear region of the motor vehicle. Experience has shown, however, that the construction space behind the passenger compartment is frequently provided for the purpose of accommodating a correspondingly large fuel tank. Thus, if a receiving space for the rear window is to be provided in the rear region of the motor vehicle, the required construction space must be provided either by components (such as, in particular, the fuel tank) or else the rear region of the motor vehicle must be made correspondingly larger. Neither alternative is desirable in the automotive industry, and therefore, to date, rear windows which can be lowered behind the passenger compartment have not yet gained acceptance.

Further rear window arrangements are disclosed in German patent document DE 43 20 492 A1 and DE 199 13 033 A1. In these disclosures the rear window is initially brought into a fully lowered position before a convertible top of the motor vehicle can be brought into a storage position.

One object of the present invention therefore is to provide an improved rear window arrangement of the type mentioned above, which requires overall less construction space within the rear region of the motor vehicle.

This and other objects and advantages are achieved by the rear window arrangement according to the invention, in which the rear window has a curvature in the vertical direction of the vehicle and can be moved along a curved movement track by means of the guide device. The effect which can therefore be achieved by the rear window, which is curved in shape in cross section in the vertical direction of the vehicle, is that, in its lowered position, the rear window finds space in a much smaller receiving space. As a result, the components which are adjacent to the receiving space of the rear window, such as, in particular, the fuel tank, can be made considerably larger, while the size of the rear region of the motor vehicle remains the same, than would be the case with a rear window of essentially planar design in the vertical direction of the vehicle.

Furthermore, according to the invention the rear window can be moved along a curved movement track by the guide device. In other words, the rear window is not to be lowered in a rectilinear, translatory movement, but rather the curved shape of the rear window is to be used in such a manner that the lowering and closing movement of the rear window also follows a curved movement track. It is thereby ensured that relatively little storage space needs to be kept free within the rear region of the motor vehicle for lowering and closing the rear window.

It has also been shown to be further advantageous to provide the rear window essentially with the shape of a ring segment in cross section in the vertical direction of the vehicle. Such a rear window can be manufactured relatively simply, and can very easily be guided on the motor vehicle because of its rotationally symmetrical shape. In this case, a rear window in the shape of a rotationally symmetrical cylinder or a rotationally symmetrical barrel has proven particularly advantageous.

The rear window arrangement according to the invention can be used particularly advantageously in the case of an open motor vehicle with a convertible top designed both as a hard top and as a soft top, since there is generally relatively little space in the rear region because of the generally very compact construction and the presence of an additional convertible-top storage space in motor vehicles of this type.

The curved movement track for lowering and closing the rear window can be realized in a particularly simple manner by lateral guide rails, since the latter ensure an interference-free sequence of movement during the lowering of the convertible top. Furthermore, guide rails of this type are very cost-effective to produce.

It has also been shown to be advantageous to use guide rails which run both within and above the receiving space of the rear window. When the rear window arrangement is used in an open motor vehicle, the lateral guide rails can be divided in a simple manner in the region of the upper end of the receiving space. The upper lateral guide rail parts are then connected fixedly to a rear moveable roof part of the convertible top, which roof part comprises the rear window opening. When the convertible top is brought into its storage position, the upper guide rail parts are stored together with the rear roof part in the convertible-stop storage space. A particularly rigid arrangement of the rear window in its upper closed position can be realized by providing an upper retaining strip for receiving the rear window, on a moveable front roof part of the convertible top. In addition, the rear window can be sealed in a simple manner via the retaining strip.

In a further refinement of the invention, the rear window can be moved between the upper position and the lowered position, even when the convertible top of the motor vehicle is folded down.

The rear window can therefore be partially or completely opened (depending on the vehicle occupants' requirements) in a simple manner, to provide a corresponding supply of fresh air.

A particularly efficient use of space can be achieved if the rear wall of the receiving space, which faces to the rear, is essentially matched to the shape of the rear window and is of curved design.

An improved use of the construction space within the receiving space can be provided by arranging at least one retaining device for a roll bar of the motor vehicle within the receiving space, on the inner side of the rear window.

If the rear window can be moved between the lowered position and the upper position even when the convertible top of the motor vehicle is folded down, then the rear window can also be assigned the function of a wind deflector when the motor vehicle is open.

Finally, it has been shown to be advantageous to delimit the receiving space by a receiving cassette which can be preassembled in a simple manner and can be arranged within the rear region of the motor vehicle during the final assembly thereof. In this case, the receiving space and the receiving cassette can have a channel seal with respect to the rear window. In the region of the channel seal, guide means are provided, which guide means run in the transverse direction of the vehicle. This provides additional stabilization of the rear window during a displacement along its guide track.

### BRIEF DESCRIPTION OF THE DRAWINGS

Further advantages, features and details of the invention emerge from the description below of two preferred exemplary embodiments and with reference to the drawings, in which:

FIG. 1 is a schematic perspective view obliquely from the top rear of the rear window arrangement according to the invention for a motor vehicle, of which only part of an upper and of a rear roof part of a convertible top can be seen;

FIG. 2 is a schematic sectional view through the rear window arrangement and the two roof parts of the convertible top along a vertical sectional plane which is in the center of the vehicle and runs in the longitudinal direction of the vehicle;

FIG. 3 is a schematic perspective view of the rear window arrangement according to FIG. 1, with the rear and the upper roof parts of the convertible top being indicated schematically in a position in which they are put away in the convertible-top storage space;

FIG. 4 is a schematic perspective view obliquely from the top rear of the rear window arrangement according to the invention according to a second embodiment, with it also being possible to see part of the upper and rear roof parts of the convertible top of the motor vehicle;

FIG. 5 is a schematic sectional view through the rear window arrangement along a vertical sectional plane which is in the center of the vehicle and runs in the longitudinal direction of the vehicle; and

FIG. 6 is a schematic perspective view of the rear window arrangement according to FIG. 4, with the two roof parts of the convertible top being indicated schematically in their storage position in which they are put away in the convertible-top storage space of the motor vehicle.

### DETAILED DESCRIPTION OF THE INVENTION

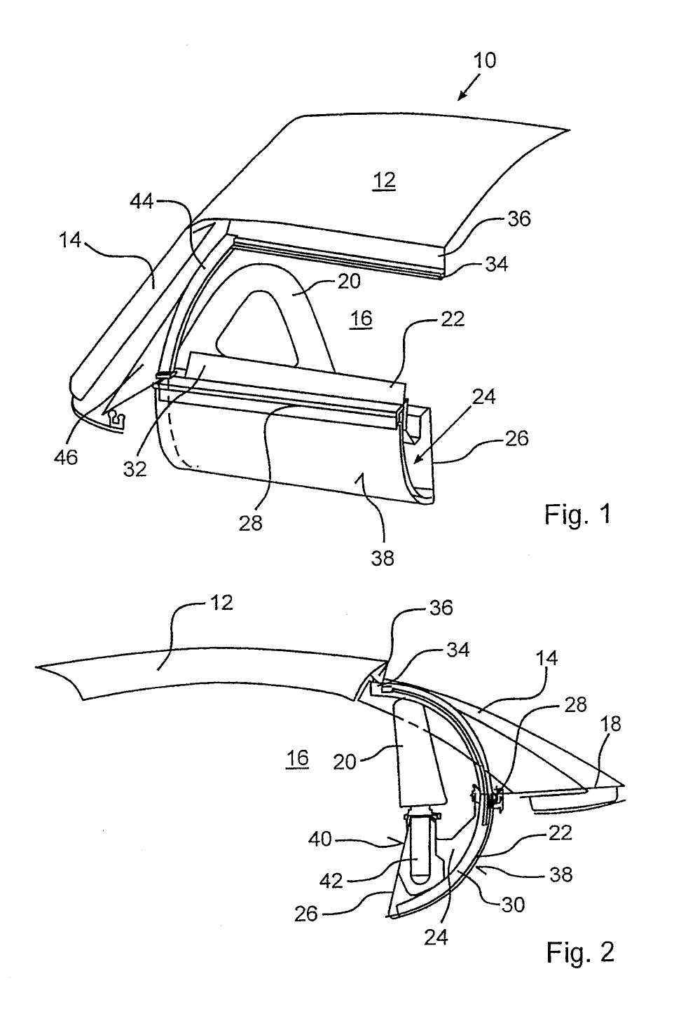

FIG. 1 illustrates, in a schematic perspective view obliquely from the top rear, part of a rear window arrangement for a motor vehicle, of which only part of a convertible top 10 with an upper roof part 12 and a rear roof part 14 can be seen. In the present exemplary embodiment, the two roof parts 12, 14 of the convertible top 10, which is configured as a whole as a hard top, comprise sheet-metal shells which are articulated to one another, and can be folded down from the closed position illustrated in FIG. 1 into a storage position within a convertible-top storage space in the rear region of the motor vehicle. The basic construction and the functioning of the convertible top 10, other than the components relating to the rear window arrangement are known, for example, from German patent document DE 44 45 944 C1 or German patent document DE 44 45 580 C1.

The convertible top 10 covers a passenger compartment 16, at the rear end of which and approximately level with a tailgate edge 18 (FIG. 2) one of the two roll bars 20 can be seen. In the present representative embodiment, the open motor vehicle is designed as a “roadster”, with a single row of vehicle seats. The rear window arrangement according to the invention may also be provided behind the passenger compartment of a motor vehicle comprising a plurality of rows of vehicle seats. The scope of the invention is likewise to be considered as incorporating the fact that the rear window arrangement can also be used in the case of a “soft top” convertible top.

As can be seen in FIG. 1, the rear window 22 of the rear window arrangement according to the invention, can be moved from an upper position completely closing the rear window opening into a lowered position. In this representative embodiment, the rear window 22 is designed as an intrinsically rigid glass or plastic window. In its lowered position, the rear window 22 is received by a receiving space 24 which is delimited by a receiving cassette 26 fastened to the motor vehicle body via fastening means (not shown). The receiving space 24 or the receiving cassette 26 is designed to be open upward in the region of a slot-shaped channel opening which runs in the transverse direction of the vehicle and is sealed with respect to the rear window 22 by means of a channel seal 28.

FIG. 2, which is a schematic sectional view along a vertical sectional plane which is in the center of the vehicle and runs in the longitudinal direction of the vehicle shows the rear window arrangement and the convertible top 10. The shape of the rear window 22 is essentially a ring segment in cross section in the vertical direction of the vehicle in this embodiment. Over its entire profile in the transverse direction of the vehicle, it has a constant profile in the form of a circumferential section of a cylinder. However, it would also be possible for the rear window 22 in the transverse direction of the vehicle to have the shape of a circumferential section of a barrel.

The rear window 22 is guided by two guide rails 30 which are arranged at the sides thereof and extend—as can be seen in particular in FIG. 2—from the upper roof part 12 as far as the lower end of the receiving space 24 or the receiving cassette 26. The two guide rails 30, as a segment of a ring, are of approximately semi-ring-shaped design in accordance with the shape of the rear window 22. In this case, the rear window 22 tapers conically upward. Accordingly, it comes into engagement at its upper lateral corner regions 32 with the associated guide rail 30 only when the upper closed position is approximately reached. A retaining strip 34 extends between the upper ends of the guide rails 30 and stabilizes the rear window 22 in its upper closed position. A seal (not shown) is also provided in the region of the retaining strip 34. The retaining strip 34 is fastened to the upper roof part 12 of the convertible top via an intermediate part 36.

In addition, the design of the receiving space 24 and of the receiving cassette 26 (which can be produced, for example, from a metal sheet or plastic) can be seen in FIG. 2. The receiving cassette 26 has a rear wall 38 which is of curved design and is matched to the circular-arc-shaped profile of the guide rails 30 which are directly adjacent to it, and/or to the shape of the rear window 22. At the lower end, the rear wall 38 merges into a front wall 40 which runs upright and is adjacent to the passenger compartment 16 of the motor vehicle. Two retaining devices 42, which are arranged within the receiving space 24, are assigned respectively to the two roll bars 20 and making use of the space remaining on the inside of the guide rails 30 and of the rear window 22.

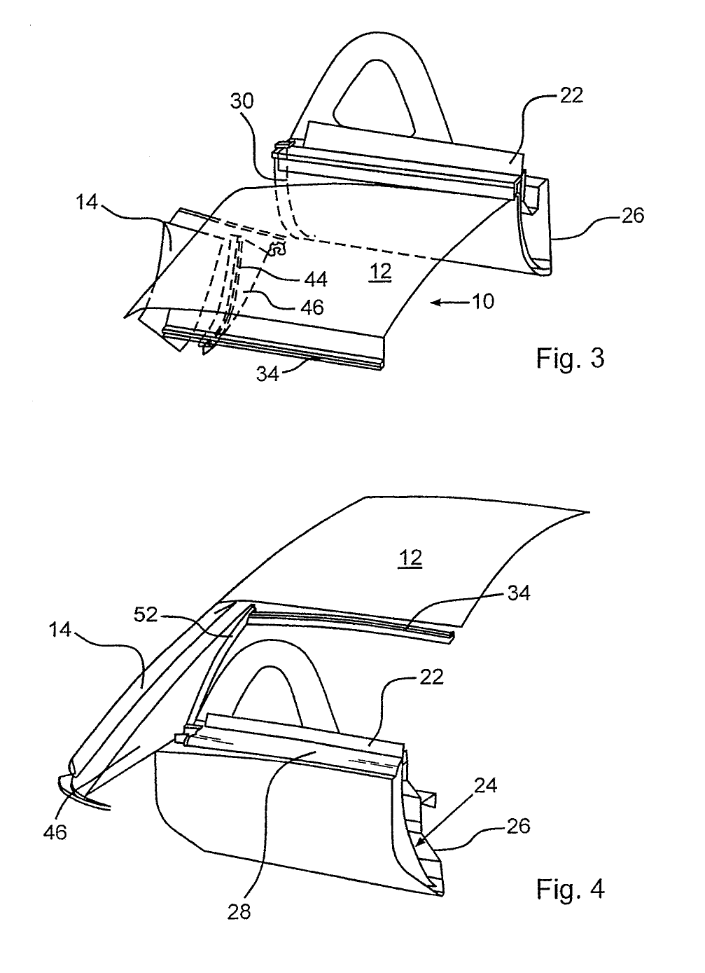

FIG. 3 shows, in a perspective view according to FIG. 1, the rear window arrangement with the convertible top 10 folded down. Accordingly, the upper roof part 12 and the rear roof part 14 have been brought into a convertible-top storage space (not shown) at the rear end of the motor vehicle. In this case, the upper roof part 12 lies parallel to its closed position. By contrast, the rear roof part 14 has been folded to the rear about a pivot axis arranged on its lower side. It can be seen that the retaining strip 34 which is assigned to the upper roof part 12 has been displaced downward together with the upper roof part 12 into the storage position.

An upper guide rail part 44, which is fixed on the inside of the roof pillars 46 of the rear roof part 14, has also been displaced downward together with said rear roof part on the lateral guide rails 30. For this purpose, the upper guide rail part 44 is divided at the upper end of the receiving space 24 or of the receiving cassette 26—in the region of the channel seal 28—from the remaining associated guide rail 30. The two lateral guide rail parts 44 are likewise formed separately from the retaining strip 34.

To fold down the convertible top 10, the rear window 22 has to be brought first of all into a lowered position until it is no longer in engagement with the upper guide rail parts 44 of the guide rails 30. (If appropriate, the convertible top 10 may also be folded down only after the rear window 22 is completely lowered.) After the rear window 22 is brought into the correspondingly lowered position, the convertible top—essentially comprising the upper roof part 12 and the rear roof part 14 with the roof pillars 46—can now be brought out of the closed position, which is illustrated in FIG. 1, into the folded-down position, which is illustrated in FIG. 3, within the convertible-top storage space.

In the folded-down position of the convertible top 10, the rear window 22 may, if appropriate, be moved between the lowered position, which is illustrated in FIG. 3, and an upper position—along the remaining guide rails 30 arranged laterally within the receiving cassette 26, such that the function of a wind deflector can additionally be realized by the rear window 22. When the convertible top 10 is closed, the rear window 22 can likewise be lowered in order to supply fresh air to the passenger compartment 16.

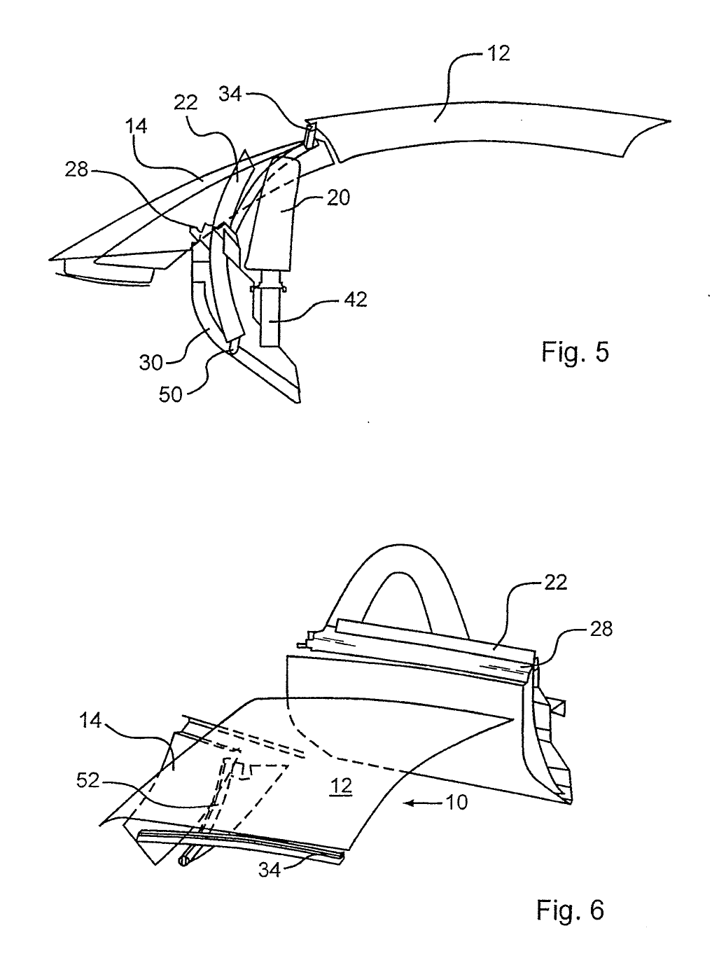

FIG. 4 to 6 illustrate the rear window arrangement in a second embodiment of the invention. FIG. 4 is a schematic perspective view obliquely from the top rear, which shows part of the rear window arrangement and of the front and rear roof parts 12, 14 of the convertible top 10 in its closed position. FIG. 5, which is a schematic sectional view along a vertical sectional plane in the center longitudinal direction of the vehicle, shows the rear window arrangement and the convertible top 10; in particular, the design of the rear window 22 and the receiving space 26 can be seen. In contrast to the exemplary embodiment according to FIGS. 1 to 3, the rear window 22 is not in the form of a circumferential section of a cylinder or of a barrel but rather has a non-rotationally symmetrical shape. In this embodiment, the lateral guide rails 30 extend from the lower end as far as approximately the upper end of the receiving space 24. The guide rails 30 are of curved design, but—matched to the shape of the rear window 22—do not have a uniform curvature along their profile. The shape of the rear wall 38 of the receiving cassette 26 of the receiving space 24 is essentially matched to the profile of the guide rails 30.

In contrast to the two upper guide rail parts 44, which are assigned to the rear roof part 14 according to the first exemplary embodiment, in the design present here only retaining strips 52 are provided above the receiving space 24, against which retaining strips the rear window 22 bears only when the upper closed position is reached. Accordingly, the guidance of the rear window 22 above the guide rails 30 takes place by means of guide means 48 which are provided in the region of the channel seal 28. In other words, the rear window 22 is held in a lower region within the guide rails 30 via a guide mechanism 50 and is guided into an upper region within the channel seal 28 by means of the guide means 48. In this case, the guide mechanism 50 can be designed such that it can be adjusted by means of a control program, and therefore the lower end of the rear window 22 is moveable not only along the guide rails 30 but also transversely with respect thereto. In this way, the curved movement track of the rear window 22 can be further influenced. Furthermore, it can be seen in particular from FIG. 5 that, in the present exemplary embodiment, the retaining device 42 for the roll bar 20 is arranged outside the receiving space 24.

Finally, FIG. 6 shows, in a schematic perspective view corresponding to FIG. 4, part of the rear window arrangement and of the convertible top 10 in its storage position in which it is placed within the convertible-top storage space (not shown). In this case, the retaining strip 34 and the lateral retaining strips 52 have in turn been put away together with the associated roof parts 12, 14 within the convertible-top storage space.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-15. (canceled)

16. A rear window arrangement for a motor vehicle, said rear window arrangement comprising:
an intrinsically rigid rear window which can be moved by means of a guide device between an upper position and a lowered position; and
a receiving space within the motor vehicle, behind a passenger compartment, for receiving the rear window;
wherein the rear window has a curvature in the vertical direction of the vehicle and is moveable along a curved movement track by means of the guide device.

17. The rear window arrangement as claimed in claim 16, wherein the rear window is substantially in the shape of a ring segment in cross section, in a vertical direction of the vehicle.

18. The rear window arrangement as claimed in claim 16, wherein the rear window is substantially in the shape of a circumferential section of one of a cylinder and a barrel.

19. The rear window arrangement as claimed in claim 16, wherein the receiving space is delimited by a receiving cassette which is fastened to the motor vehicle body.

20. The rear window arrangement as claimed in claim 16, further comprising guide or retaining parts of the guide device, which can be transferred into a convertible-top storage space by means of moveable roof parts of a convertible top of the motor vehicle.

21. The rear window arrangement as claimed in claim 16, wherein the guide device has curved lateral guide rails.

22. The rear window arrangement as claimed in claim 20, wherein:
the lateral guide rails are divided in a region of the upper end of the receiving space; and
upper lateral guide rail parts are connected fixedly to a moveable rear roof part (14) of the convertible top.

23. The rear window arrangement as claimed in claim 20, wherein the lateral guide rails run within the receiving space for the rear window.

24. The rear window arrangement as claimed in claim 21, wherein:
the guide device comprises an upper retaining strip for receiving the rear window in its upper position; and
said retaining strip is connected fixedly to a moveable front roof part of the convertible top.

25. The rear window arrangement as claimed in claim 20, wherein the rear window can be moved between the upper position and the lowered position even when the convertible top of the motor vehicle is folded down.

26. The rear window arrangement as claimed in claim 16, wherein the receiving space comprises a rear wall which is of curved design in the vertical direction of the vehicle.

27. The rear window arrangement as claimed in claim 16, wherein at least one retaining device for a roll bar is arranged within the receiving space.

28. The rear window arrangement as claimed in claim 16, wherein a front wall of the receiving space is adjacent to a passenger compartment of the motor vehicle.

29. The rear window arrangement as claimed in claim 16, wherein the rear window is moveable into an intermediate position between the upper position and the completely lowered position.

30. The rear window arrangement as claimed in claim 16, wherein:
the receiving space comprises, on an upper side, a channel seal with respect to the rear window;
in the region of said channel seal, guide means of the guide device, which guide means run in a direction transverse to the vehicle.

31. A rear window arrangement for a motor vehicle, said rear window arrangement comprising:
a rigid rear window;
a guide device for moving said rear window between an upper position and a lowered position;
a movement track for guiding movement of said rear window by said guide device, between said upper position and said lowered position;
a receiving space within the motor vehicle for accommodating said rear window behind a passenger compartment of said vehicle when said rear window is in said lowered position; wherein,
a cross section of said rear window in a vertical longitudinal plane of said vehicle has a curvature; and
a cross section of said movement track also has a curvature in said vertical longitudinal plane.
